(19) United States
(12) Patent Application Publication
(10) Pub. No.: US 2019/0181729 A1
(43) Pub. Date: Jun. 13, 2019

(54) GROUND STRUCTURE OF DRIVE MOTOR

(71) Applicants: Hyundai Motor Company, Seoul (KR); Kia Motors Corporation, Seoul (KR)

(72) Inventors: Jung Shik Kim, Seoul (KR); Hyoungjun Cho, Suwon (KR); Sanghoon Moon, Yongin (KR); Kyungsoo Park, Daejeon (KR); Suhyun Bae, Daegu (KR); Yong Jae Lee, Hwaseong (KR); Nyeonhan Hong, Donghae (KR); Jai Hak Kim, Gunpo (KR)

(21) Appl. No.: 16/103,665

(22) Filed: Aug. 14, 2018

(30) Foreign Application Priority Data
Dec. 11, 2017 (KR) 10-2017-0169267

(51) Int. Cl. H02K 11/40; H02K 5/124; H02K 5/173; H02K 5/22; H02K 7/08

(52) U.S. Cl. CPC H02K 11/40; H02K 5/124; H02K 7/083; H02K 5/225; H02K 5/1732

(57) ABSTRACT

A ground structure of a drive motor is provided. The ground structure of the drive motor forms a current path of a motor housing and a rotation shaft. The structure includes a current carrying housing that is fixed to the motor housing and accommodates a least one end portion of the rotation shaft and a current carrying medium that has conductivity and is included in an inner space of the current carrying housing.

### CROSS-REFERENCE TO RELATED APPLICATION

This application claims priority to and the benefit of Korean Patent Application No. 10-2017-0169267 filed on Dec. 11, 2017, the entire contents of which are incorporated herein by reference.

### BACKGROUND

### (a) Field of the Invention

The present invention relates to a drive motor for an electric power driven vehicle, and more particularly, to a ground structure of a drive motor that prevents a damage of a bearing caused by a shaft current of the drive motor.

### (b) Description of the Related Art

Recently, a pure electric powered eco-friendly vehicle such as an electric vehicle or a fuel cell vehicle has been developed. An electric motor as a drive motor is mounted on the electric powered eco-friendly vehicle as a drive source for obtaining a rotational force by electric energy instead of an internal combustion engine such as an engine. The drive motor includes a motor housing, a stator fixedly installed inside the motor housing, and a rotor rotating around a rotation shaft that is a driving shaft. A gap is disposed between the stator and the rotor.

Particularly, the drive motor is required to have high efficiency and high output density. The electric vehicle needs to obtain all the power of the vehicle from the drive motor, and therefore, a further improved torque and output are required. The drive motor is required to be designed to be smaller and to exhibit high torque density and high output density, to generate a high level of torque and output within a limited vehicle space. Thus, the drive motor may be vulnerable to electromagnetic interference and leakage problems due to internally higher electromagnetic energy acts in the confined space.

One of the electromagnetic interference and leakage problems is a shaft current. When a three-phase inverter driving the drive motor performs high-speed switching control, a harmonic noise voltage (e.g., a common voltage) is generated. An electric field caused by the common voltage moves a free electron of the rotor steel plate to generate the shaft current in the rotation shaft. In other words, the harmonic noise voltage induces a voltage across the shaft of the rotor using a parasitic capacitor between the stator and the rotor to generate the shaft current.

The shaft current generated in the shaft of the rotor causes a potential difference between an inner race and an outer race of a bearing when the shaft current flows along the shaft or through the bearing to the motor housing, and a discharge mechanism inside the bearing causes the bearing erosion. The erosion substantially affects durability of the drive motor causing the bearing to be damaged. In recent years, a magnitude of the shaft current generated in the drive motor having high torque density and a high output density has increased. Accordingly, there is a need in a relevant field of technology to develop a ground structure that transmits the shaft current generated in the rotation shaft to the motor housing to reduce the shaft current caused in the rotation shaft of the drive motor.

The above information disclosed in this section is merely for enhancement of understanding of the background of the invention and therefore it may contain information that does not form the prior art that is already known in this country to a person of ordinary skill in the art.

### SUMMARY

The present invention provides a ground structure of a drive motor capable of securing a current path for transmitting a shaft current generated in a rotation shaft to a motor housing.

An exemplary embodiment of the present invention provides the ground structure of the drive motor that forms a current path of the motor housing and the rotation shaft and may include: a current carrying housing that is fixed to the motor housing and accommodates a least one end portion of the rotation shaft; and a current carrying medium that has conductivity and is disposed in an inner space of the current carrying housing.

The current carrying housing may rotatably support the rotation shaft and may be separated from a bearing that rotatably supports the rotation shaft and may be coupled to the motor housing. The current carrying housing may include a housing body that is a metal conductor. The current carrying housing may include: a housing body having one open surface; and a sealing cover coupled to the open surface of the housing body and forming an inner space. The housing body may include a metal conductor fixed to the motor housing. The sealing cover may be made of a plastic material.

The sealing cover may include a sealing portion made of a rubber material and formed at a portion coupled to the housing body and a portion coupled to the end portion of the rotation shaft. The current carrying medium may include a current carrying filler filled in an inner space of the current carrying housing. In particular, the current carrying filler may include a current carrying fluid or a current carrying powder. Alternately, the current carrying filler may include a mixture of a current carrying fluid and a current carrying powder. The end portion of the rotation shaft accommodated by the current carrying housing may have an outer diameter less than an outer diameter of a remaining portion of the rotation shaft.

Another exemplary embodiment of the present invention may provide the ground structure of the drive motor electrically connecting a rotation shaft and a motor housing. The drive motor may include a stator fixed to an inside of the motor housing, a rotor rotatably coupled to the motor housing via the rotation shaft with a gap between the rotor and the stator, and a bearing fixed to the motor housing and rotatably supporting the rotation shaft. The ground structure may include: a current carrying housing that is fixed to the motor housing in a direction in which the current carrying housing faces the bearing and accommodates a least one end portion of the rotation shaft in an inner space of the current carrying housing; and a current carrying filler that is configured to carry an electric current generated in the rotation shaft to the motor housing and is filled in the inner space of the current carrying housing.

The current carrying filler may be a current carrying medium and may include water or an antifreeze. In particular, the current carrying filler may include a current carrying powder and may include at least one of graphite, aluminum, and copper. Alternately, the current carrying filler may include a mixture of a current carrying fluid and a current carrying powder. The current carrying housing may include: a housing body having one open surface and including a metal conductor; and a sealing cover coupled to the open surface of the housing body and forming an inner space.

The sealing cover may be made of a plastic material and may include a coupling aperture to be coupled to the end portion of the rotation shaft. The sealing cover may include a sealing portion made of a rubber material and may be formed at a portion coupled to the housing body and at the coupling aperture. The end portion of the rotation shaft fitted in the coupling aperture may have an outer diameter less than an outer diameter of a remaining portion of the rotation shaft.

The exemplary embodiment of the present invention may prevent a discharge mechanism inside a bearing from causing the bearing erosion (e.g., the bearing electrolytic corrosion erosion) by transferring the shaft current generated in the rotation shaft through the current carrying housing and the current carrying filler to the motor housing. Further, the effects which may be obtained or predicted by the exemplary embodiment of the present invention will be directly or implicitly disclosed in the detailed description of the exemplary embodiments of the present invention. That is, various effects which are predicted by the exemplary embodiments of the present invention will be disclosed in the detailed description to be described below.

### BRIEF DESCRIPTION OF THE DRAWINGS

While the drawings are described in connection with what is presently considered to be practical exemplary embodiments, it is to be understood that the invention is not limited to the disclosed drawings.

FIG. 1 is a schematic view showing an example of a drive motor to which a ground structure according to an exemplary embodiment of the present invention is applied;

FIGS. 2A-2B are cross-sectional views illustrating the ground structure of the drive motor according to an exemplary embodiment of the present invention;

FIG. 3 is a perspective view illustrating the ground structure of the drive motor according to an exemplary embodiment of the present invention;

FIGS. 4A-4B are views showing a current carrying housing applied to the ground structure of the drive motor according to an exemplary embodiment of the present invention;

FIGS. 5A-5C are views showing an example of a current carrying filler applied to the ground structure of the drive motor according to an exemplary embodiment of the present invention; and

FIG. 6 is a view for illustrating an operation of the ground structure of the drive motor according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

The present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention.

Portions having no relation with the description will be omitted in order to explicitly explain the present invention, and the same reference numerals will be used for the same or similar elements throughout the specification. In the drawings, size and thickness of each element is approximately shown for better understanding and ease of description. Therefore, the present invention is not limited to the drawings, and the thicknesses of layers, films, panels, regions, etc., are exaggerated for clarity.

Further, in the following detailed description, names of constituents, which are in the same relationship, are divided into “the first”, “the second”, and the like, but the present invention is not limited to the order in the following description. In the specification, the terminology such as “. . . unit”, “. . . means”, “. . . part”, or “. . . member”, which is disclosed in the specification, refers to a unit of an inclusive constituent which performs at least one of the functions or operations.

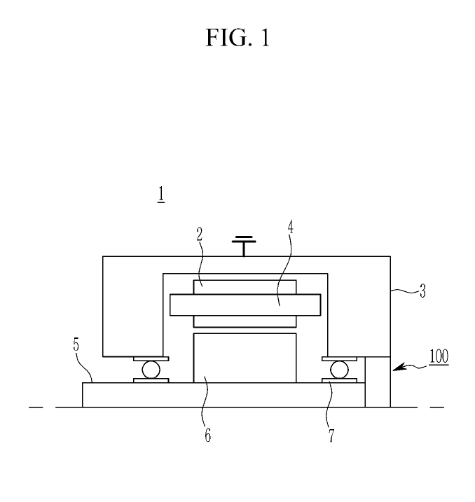

FIG. 1 is a schematic view showing an example of a drive motor to which a ground structure according to an exemplary embodiment of the present invention is applied. Referring to FIG. 1, the ground structure 100 of the drive motor 1 may be applied to a drive motor of a pure environmentally friendly vehicle such as an electric vehicle or a fuel cell vehicle.

The ground structure 100 of the drive motor 1 may be applied to a small and medium size drive motor of a hybrid vehicle (e.g., a hybrid electric vehicle (HEV) or a plug-in hybrid electric vehicle (PHEV)) using a driving force of an engine and an electric power. For example, the drive motor 1 may include a permanent magnet synchronous motor (PMSM) or a wound rotor synchronous motor (WRSM). However, it should be understood that the present invention is not limited to the drive motor of the environmentally friendly vehicle and a technical idea of the present invention may be applied to a drive motor used in various industrial fields.

Particularly, the drive motor 1 may include a stator 2 fixed to an inside of a motor housing 3 and a rotor 6 configured to rotate around a rotation shaft 5 that is a driving shaft. A gap may be disposed between the stator and the rotor. For example, the drive motor 1 may be an inner rotor type synchronous motor in which the rotor 6 is disposed inside the stator 2. A stator coil 4 may be wound around the stator 2 and the rotation shaft 5 may be rotatably coupled to the motor housing 3 through a bearing 7. The ground structure 100 of the drive motor may electrically connect the rotation shaft 5 and the motor housing 3. The ground structure 100 of the drive motor may transfer a shaft current generated in the rotation shaft 5 to the motor housing 3 and may prevent bearing erosion due to a discharge mechanism among the rotation shaft 5, the bearing 7, and the motor housing 3.

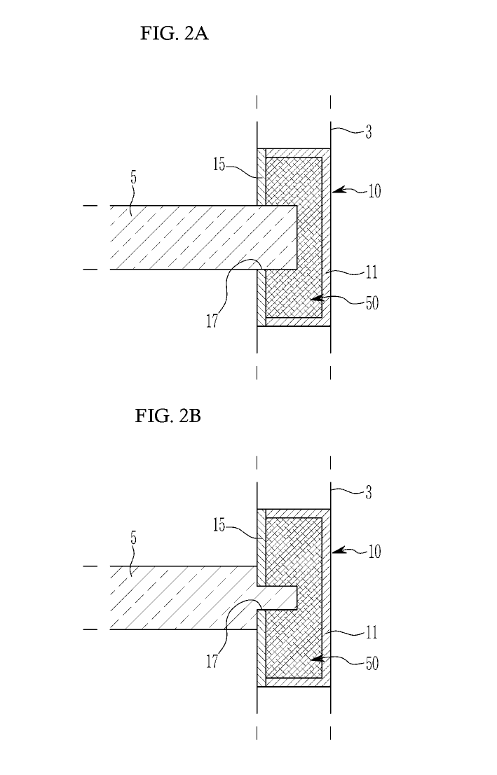

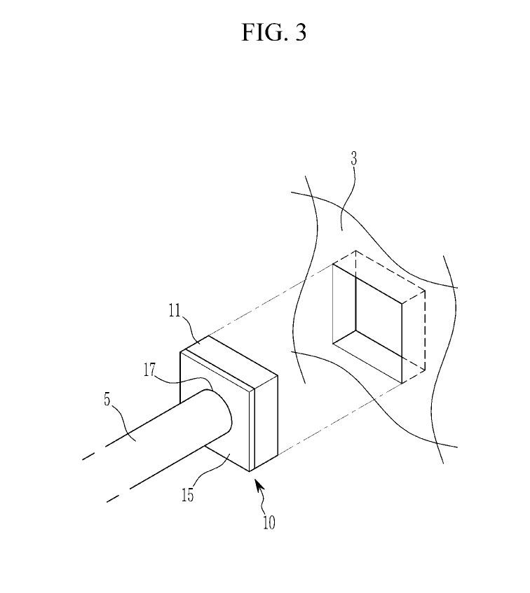

FIGS. 2A-2B are cross-sectional views illustrating the ground structure of the drive motor according to an exemplary embodiment of the present invention. FIG. 3 is a perspective view illustrating the ground structure of the drive motor according to an exemplary embodiment of the present invention. Referring to FIG. 1 to FIG. 3, the ground structure 100 of the drive motor may include a current carrying housing 10 and a current carrying medium 50 that form a current path (e.g., a current carrying path) between the motor housing 3 and the rotation shaft 5.

The current carrying housing 10 may be made of a metal material having conductivity. In particular, the current carrying housing 10 may be fixed to the motor housing 3 in a press-fitting manner separately from the bearing 7 coupled to the motor housing 3. The current carrying housing 10 may be fixed to the motor housing 3 in a direction in which the current carrying housing faces the bearing 7. Additionally, the current carrying housing 10 may form a substantially enclosed inner space. The current carrying housing 10 may include a least one end portion of the rotation shaft 5 in the inner space. In other words, the current carrying housing 10 may support the end portion of the rotation shaft 5 and may accommodate the end portion in the inner space. The end portion of the rotation shaft 5 may be accommodated inside the current carrying housing 10 through one side of the current carrying housing.

As shown in FIG. 1, the current carrying housing 10 may be installed on only one side of the motor housing 3 to accommodate the end portion of the rotation shaft 5. However, the present invention is not limited to this and the current carrying housing 10 may be installed on both sides of the motor housing 3 to accommodate both end portions of the rotation shaft 5.

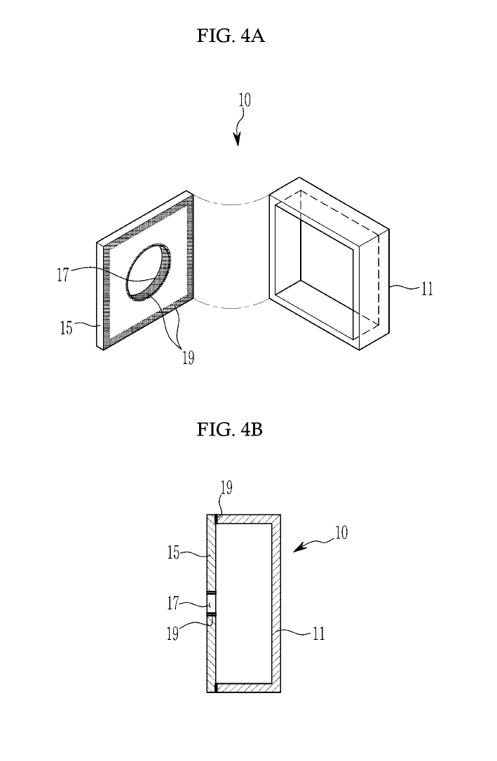

FIGS. 4A-4B are views showing the current carrying housing applied to the ground structure of the drive motor according to an exemplary embodiment of the present invention. Referring to FIG. 3 and FIGS. 4A-4B, the current carrying housing 10 may include a housing body 11 and a sealing cover 15 which are mutually engageable.

One surface of the housing body 11 may be open and the housing body may be formed as a rectangular housing body, as shown in FIGS. 4A-4B. Alternately, the housing body 11 may be a circular housing body. The housing body 11 may include a metal conductor fixed to the motor housing 3. The sealing cover 15 may close an open end (e.g., an open surface) of the housing body 11 and may be coupled to the open end of the housing body 11 to form a sealed space inside the sealing cover.

The sealing cover 15 may be made of a plastic material and may form a coupling aperture 17 to be engaged with an end portion of the rotation shaft 5. In particular, the sealing cover 15 may include a sealing portion 19 made of a rubber material. The sealing cover 15 may be formed with a portion that engages with the housing body 11 and a portion that engages with the end portion of the rotation shaft 5. In other words, a first portion of the sealing cover 15 may engage with the housing body 11 and a second portion of the sealing cover may engage with the end portion of the rotation shaft 5. The sealing portion 19 may be formed at an edge portion of the sealing cover 15 that engages with the housing body 11 and may be formed on an inner circumferential surface of the coupling aperture 17. The sealing portion 19 may seal a coupling portion between the housing body 11 and the sealing cover 15 and may seal a portion between the end portion of the rotation shaft 5 and the coupling aperture 17.

As shown in FIG. 2A, the current carrying housing 10 may accommodate in an inner space thereof the end portion of the rotation shaft 5 having the same outer diameter as the opening through the coupling aperture 17 of the sealing cover 15. As shown in FIG. 2B, the current carrying housing 10 may accommodate therein the end portion of the rotation shaft 5 having an outer diameter less than an outer diameter of the remaining portion of the rotation shaft 5 through the coupling aperture 17 of the sealing cover 15. In other words, in FIG. 2B, the portion of the rotation shaft 5 that is accommodated in the current carrying housing 20 may have an outer diameter that is less than the outer diameter of the portion of the rotation shaft 5 that is not accommodated in the current carrying housing 20. The end portion of the rotation shaft 5 accommodated in the internal space of the current carrying housing 10 may be formed to have the outer diameter less than the outer diameter of the portion disposed outside of the current carrying housing 10 to reduce a rotation loss of the drive motor by minimizing a friction of the end portion of the rotation shaft with respect to the sealing cover 15.

As shown in FIGS. 2A-2B, the current carrying medium 50 may be provided in an inner space of the current carrying housing 10. The current carrying medium 50 may electrically connect the rotation shaft 5, the current carrying housing 10, and the motor housing 3 to form a current path for transferring the shaft current. The current carrying medium 50 may be a conductive medium for transferring the shaft current generated in the rotation shaft 5 to the motor housing 3 and may include a current carrying filler 51 filled in an inner space of the current carrying housing 10.

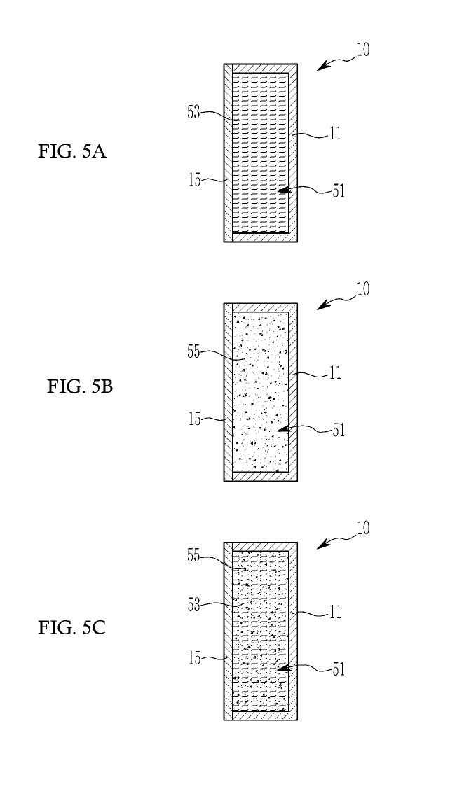

FIGS. 5A-5C are views showing an example of the current carrying filler applied to the ground structure of the drive motor according to an exemplary embodiment of the present invention. Referring to FIG. 5A, the current carrying filler 51 may include a current carrying fluid 53 filled in the inner space of the current carrying housing 10. For example, the current carrying fluid 53 may include water capable of transferring an electric current or a fluid such as an antifreeze capable of coping with temperature.

As shown in FIG. 5B, the current carrying filler 51 may include a current carrying powder 55 filled in the inner space of the current carrying housing 10. For example, the current carrying powder 55 may include a powder of graphite, aluminum, or copper that has a relatively high conductivity. The current carrying powder 55 may include any one of the materials, and may include a powder mixed with other materials. As shown in FIG. 5C, the current carrying filler 51 may include a mixture of the current carrying fluid 53 and the current carrying powder 55.

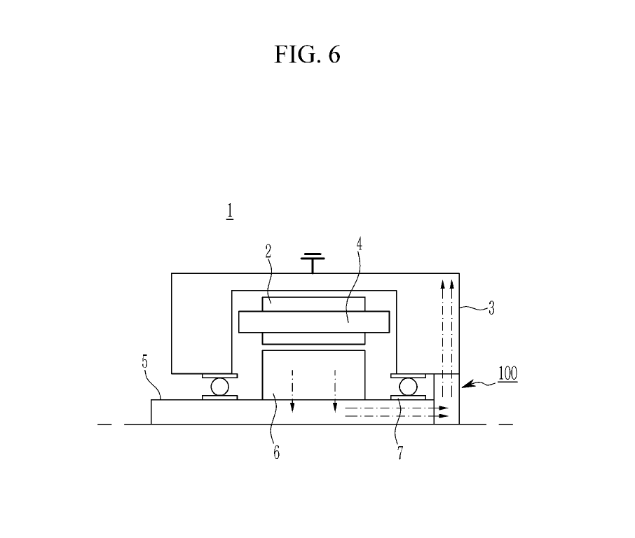

Hereinafter, an operation of the ground structure 100 of the drive motor will be described in detail with reference to the accompanying drawings. FIG. 6 is a view illustrating an operation of the ground structure of the drive motor according to an exemplary embodiment of the present invention. Referring to FIG. 6, when an inverter configured to operate the drive motor 1 performs high-speed switching control, a harmonic noise voltage may be generated. The harmonic noise voltage may induce a voltage across the shaft 5 of the rotor 5 using a parasitic capacitor between the stator 30 and the rotor 50 to generate the shaft current in the shaft 5.

The ground structure 100 may be formed by accommodating the end portion of the rotation shaft 5 in an internal sealed space of the current carrying housing 10 and by filling the current carrying filler 51 in the current carrying housing 10. A current path may be formed for electrically connecting the rotation shaft 5, the current carrying housing 10, and the motor housing 3 through the current carrying filler 51. Therefore, the shaft current generated in the rotation shaft 5 may be transferred to the motor housing 3 through the current carrying housing 10 and the current carrying filler 51. Accordingly, the exemplary embodiment of the present invention prevents an abnormal current due to the discharge mechanism in the bearing 7.

Since a current path for electrically connecting a rotation shaft and a motor housing is not secured in a related art, a discharge phenomenon in which an electric spark occurs in a bearing positioned closest to the rotation shaft and the motor housing may be generated thus causing bearing erosion. However, according to the exemplary embodiment of the present invention, since the current path for the rotation shaft 5 and the motor housing 3 is secured through the ground structure 100, the erosion of the bearing 7 generated by a potential difference between the bearing ball and inner and outer races of the bearing may be prevented.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

1: drive motor

2: stator

3: motor housing

4: stator coil

5: rotation shaft

6: rotor

7: bearing

10: current carrying housing

11: housing body

15: sealing cover

17: coupling hole

19: sealing portion

50: current carrying medium

51: current carrying filler

53: current carrying fluid

55: current carrying powder

What is claimed is:

1. A ground structure of a drive motor that forms a current path of a motor housing and a rotation shaft, comprising:
a current carrying housing that is fixed to the motor housing and accommodates a least one end portion of the rotation shaft; and
a current carrying medium that has conductivity and is included in an inner space of the current carrying housing.

2. The ground structure of claim 1, wherein the current carrying housing rotatably supports the rotation shaft and is separated from a bearing that rotatably supports the rotation shaft and is coupled to the motor housing.

3. The ground structure of claim 1, wherein the current carrying housing includes a housing body that is a metal conductor.

4. The ground structure of claim 1, wherein the current carrying housing includes:
a housing body having an open surface; and
a sealing cover coupled to the open surface of the housing body and forming an inner space.

5. The ground structure of claim 4, wherein the housing body includes a metal conductor fixed to the motor housing, and wherein the sealing cover is made of a plastic material.

6. The ground structure of claim 4, wherein the sealing cover includes a sealing portion that is made of a rubber material and is formed with a first portion thereof coupled to the housing body and a second portion thereof coupled to the end portion of the rotation shaft.

7. The ground structure of claim 1, wherein the current carrying medium includes a current carrying filler filled in an inner space of the current carrying housing.

8. The ground structure of claim 7, wherein the current carrying filler includes a current carrying fluid.

9. The ground structure of claim 7, wherein the current carrying filler includes a current carrying powder.

10. The ground structure of claim 7, wherein the current carrying filler includes a mixture of a current carrying fluid and a current carrying powder.

11. The ground structure of claim 1, wherein the end portion of the rotation shaft accommodated in the current carrying housing has an outer diameter less than an outer diameter of a portion of the rotation shaft disposed outside of the current carrying housing.

12. A ground structure of a drive motor electrically connecting a rotation shaft and a motor housing wherein the drive motor includes a stator fixed to an inside of the motor housing, a rotor rotatably coupled to the motor housing via the rotation shaft with a gap between the rotor and the stator, and a bearing fixed to the motor housing and rotatably supporting the rotation shaft, the ground structure comprising:
a current carrying housing that is fixed to the motor housing in a direction in which the current carrying housing faces the bearing and accommodates a least one end portion of the rotation shaft in an inner space of the current carrying housing; and
a current carrying filler that is configured to transfer an electric current generated in the rotation shaft to the motor housing and is filled in the inner space of the current carrying housing.

13. The ground structure of claim 11, wherein the current carrying filler is a current carrying medium and includes water or an antifreeze.

14. The ground structure of claim 11, wherein the current carrying filler includes a current carrying powder and includes at least one of graphite, aluminum, and copper.

15. The ground structure of claim 11, wherein the current carrying filler includes a mixture of a current carrying fluid and a current carrying powder.

16. The ground structure of claim 11, wherein the current carrying housing includes:
a housing body having an open surface and including a metal conductor; and
a sealing cover coupled to the open surface of the housing body and forming an inner space.

17. The ground structure of claim 16, wherein the sealing cover is made of a plastic material and includes a coupling aperture to be coupled to the end portion of the rotation shaft.

18. The ground structure of claim 17, wherein the sealing cover includes a sealing portion that is made of a rubber material and is formed at a portion coupled to the housing body and at the coupling aperture.

19. The ground structure of claim 17, wherein the end portion of the rotation shaft fitted in the coupling aperture has an outer diameter less than an outer diameter of a portion of the rotation shaft disposed outside of the current carrying housing.
